(19) United States
(12) Patent Application Publication
(10) Pub. No.: US 2014/0319780 A1
(43) Pub. Date: Oct. 30, 2014

(54) USE OF DISSIMILAR METALS IN FLOATING STYLE SEALS

(71) Applicant: CATERPILLAR INC., Peoria, IL (US)

(72) Inventor: Daniel P. Vertenten, Naperville, IL (US)

(73) Assignee: Caterpillar Inc., Peoria, IL (US)

(21) Appl. No.: 13/869,513

(22) Filed: Apr. 24, 2013

(51) Int. Cl. F16J 15/16

(52) U.S. Cl. CPC F16J 15/16
USPC 277/579; 29/428; 29/460

(57) ABSTRACT

A floating style seal assembly is provided. The floating style seal assembly includes a first mating seal ring and a second metal mating seal ring. The first and the second mating seal rings are composed of metals that are dissimilar from each other. A method of making a floating style seal is also provided. The method includes providing a first mating seal ring and providing a second mating seal ring wherein the first and second mating seal rings are composed of metals dissimilar from each other.

### TECHNICAL FIELD

The present disclosure relates generally to floating style seals, and more particularly to floating style seals having two mating seal rings that are composed of dissimilar metals and can operate at higher speeds without failure.

### BACKGROUND

Floating style seals, also known as duo-cone seals, are a type of mechanical seal. Floating style seals are used in many types of industrial equipment including trucks and track-type machines. These seals are designed to protect underlying components, such as bearings, by keeping out debris and by preventing leakage of protective lubricants. Such machines typically operate in environments that are highly destructive to seals and consequently to the underlying bearings. As a result, these seals must be resistant to corrosion and be able to withstand heavy loads, high velocities, increased temperatures, and harmful effects of dirt and debris.

Floating style seals have greatly improved track roller bearing life. However, while satisfactory for the normal operation of the average track-type machine or truck, current metal face seals have some drawbacks when applied to large high speed trucks and track machines. For example, when the seal diameter gets large, the surface velocity at the seal face increases, which produces problems due to increased heat and radial forces. In addition, under some conditions, dirt and debris can enter at the seal face. This dirt and debris increases the coefficient of friction between seal faces, thereby further damaging seal surfaces.

Conventional floating style seals are composed of common materials. Current seal materials include a variety of hard metals and alloys, such as nihard, C6 (a nickel-chromium-boron alloy), and/or cobalt-based alloys. These alloys are expensive and their durability can be a life-limiting factor for many seal rings. Further, heat generated by the high friction between seal ring components contributes to the setting of rubber toric rings, thereby limiting seal life.

One type of floating style seal includes an annular seal assembly having two mating rings in which the mating flange of one ring is coated with chromium oxide ceramic or aluminum oxide ceramic or tungsten carbide ceramic while the other ring is left untreated. (WO8700902A1). Another floating style seal includes a seal having two mating L-shaped sling rings where one of the sliding rings is made of metal preferably steel or aluminum alloy while the other ring is made of plastics. (DE4018106A1).

None of these known floating style seals, however, uses combinations of dissimilar metals. Furthermore, the seals described above have some disadvantages. For example, the top speed of these known seals is limited because these seals will fail due to galling and adhesive wear at higher speeds. This is particularly true for larger diameter seals.

The presently disclosed seal assembly is directed to overcoming one or more shortcomings in currently available floating seals.

### SUMMARY

In accordance with some embodiments of the present disclosure, a seal assembly is provided. The floating style seal assembly includes a first mating seal ring and a second metal mating seal ring. The first and the second mating seal rings comprise metals that are dissimilar from each other. The seal assembly is a floating style seal.

In accordance with some embodiments of the present disclosure, a method of making a sealing assembly is provided. The method includes providing a first mating seal ring and providing a second mating seal ring wherein the first and second mating seal rings comprise metals dissimilar from each other and the seal assembly is a floating style seal.

In accordance with some embodiments of the present disclosure, a method of making a sealing assembly is provided. The method includes a means for providing a first mating seal ring and a means for providing second mating seal ring. The first and second mating seal rings comprise metals dissimilar to each other and the seal assembly is a floating style seal.

### BRIEF DESCRIPTION OF THE DRAWINGS

FIG. 1 presents a wheel station including a floating style seal according to an embodiment of the present disclosure.

FIG. 2 presents a perspective view of a floating style seal according to an embodiment of the present disclosure.

FIG. 3 presents a cross-sectional view of the seal assembly illustrated in FIG. 2.

### DETAILED DESCRIPTION

The present invention relates to a seal device disposed in crawler roller, reduction gear, hydraulic motor, track roller or the like. More particularly, the invention relates to a seal device for crawler roller, hydraulic motor or the like used in construction machinery, which provides an effective seal against a process.

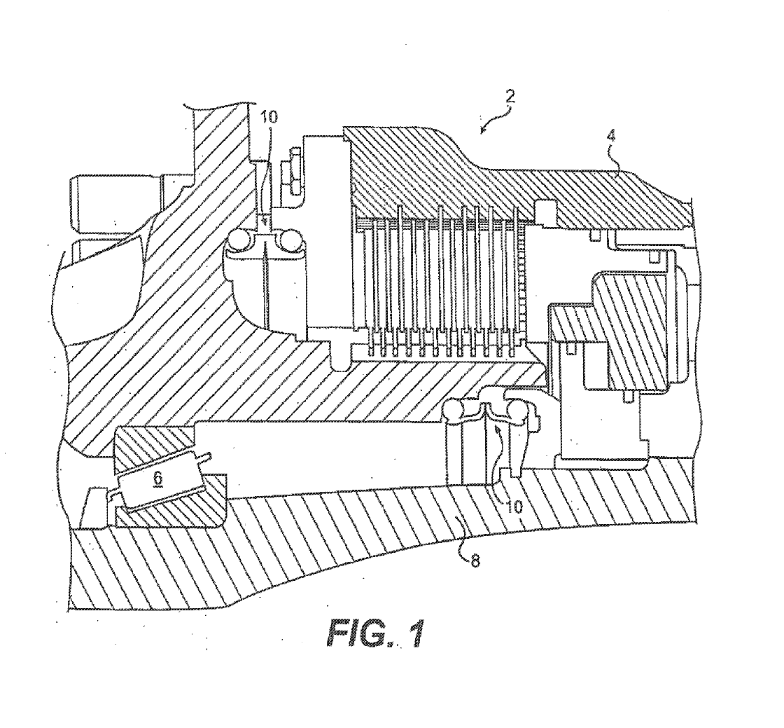

FIG. 1 illustrates a wheel station 2 including two floating style seal assemblies 10, according to an exemplary disclosed embodiment. Wheel station 2 further includes a wheel station housing 4, at least one bearing 6, and a wheel shaft 8. A lubricant may be contained within the wheel station 2. Seal assemblies 10 may be configured to prevent leakage of lubricant from wheel station 2. Further, seal assemblies 10 will also prevent dirt and debris from entering wheel station 2 and potentially damaging bearings 6, wheel shaft 8, surfaces of the seal rings, or other components of wheel station 2.

As shown, seal assemblies 10 represent Duo-Cone seal rings, as produced by Caterpillar Inc. Further, seal assemblies 10 are shown on a wheel station 2. However, seal assemblies 10 of the present disclosure can include any seal ring design and may be used in a variety of different work machines or work machine components. For example, seal assemblies 10 of the present disclosure may be used in work machines such as tractors, pumps, augers, scrapers, axles, skidders, backhoes shovels, classifiers, ski lifts, tractors, conveyors, transporters, drill rigs, trucks, excavators, tunneling machines, graders, wagons, haulers, railway equipment, loaders, and military vehicles. Further, seal assemblies 10 of the present disclosure may be used in a variety of different machine components, including axles, final drive applications, wheel applications, and undercarriage applications. In addition, seal assemblies 10 may include any metal-metal seal ring size, design, or configuration, including, for example, Heavy Duty Dual Face seals.

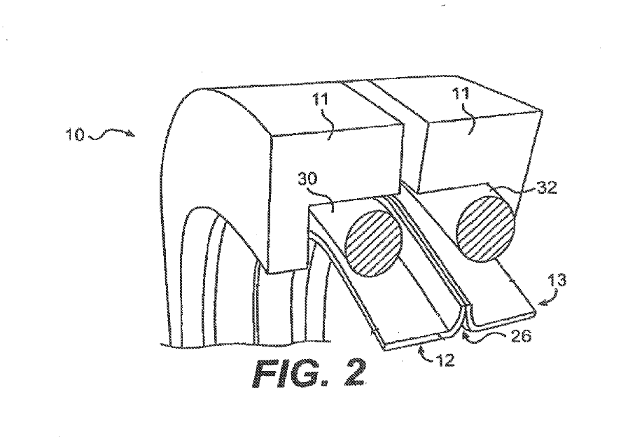

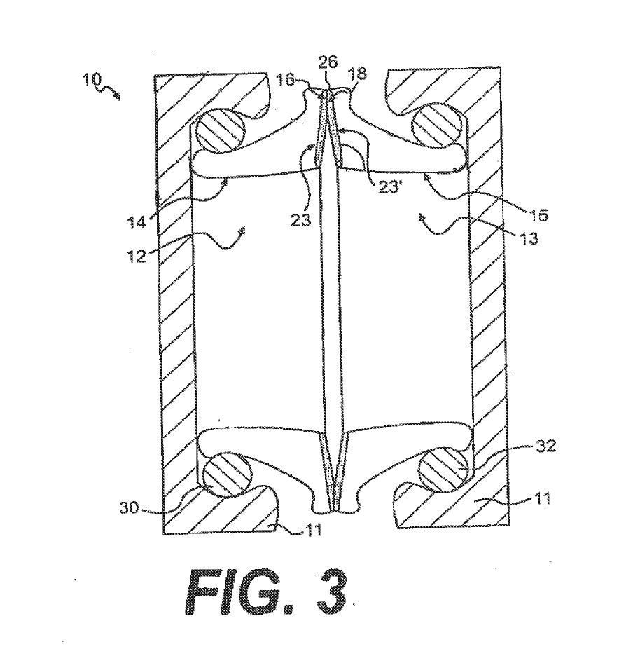

FIGS. 2 and 3 illustrate more detailed views of a floating style seal assembly 10, according to an embodiment of the present disclosure. FIG. 2 provides a perspective view of a portion of seal assembly 10, and FIG. 3 provides a cross sectional view of seal assembly 10, as shown in FIG. 2. As shown, seal assembly 10 includes first and second mating seal rings 12, 13.

The seal assembly 10 may be contained in a seal ring housing 11 and may further include a first toric 30 and a second toric 32. As shown, housing 11 includes a representative housing 11 design, but any suitable housing 11 may be selected depending on the ring design, size, and application. Further, torics 30, 32 can be produced from a variety of suitable rubber or elastomeric materials and may be configured to secure seal rings 12, 13 within housing 11. Torics 30, 32 may also produce a fluid-tight seal between housing 11 and seal rings 12, 13.

The first and second mating seal rings 12, 13 may be formed from metals that are dissimilar from each other. The first and second mating seal rings may be forged or cast of the dissimilar metals. A wide variety of metals may be used to form the first and second mating seal rings 12, 13 provided that the metal selected to form the first mating seal ring 12 is dissimilar than the metal selected to form the second mating seal ring 13. By dissimilar, it is meant that the metals selected may have a high difference in bulk chemical composition. In other words, the dominant element in one metal may be present in an amount that is 60% or greater than is present in the other metal. Selecting metals for the seal rings 12, 13 that are dissimilar from each other will result in seal rings 12, 13 that are more resistant to galling and therefore enable the seal assembly 10 to operate at higher speeds without failure. Mating seal rings composed of these dissimilar metals were tested and shown to operate at speeds 30% higher than other seals having seal rings 12, 13 that were composed of metals that were not dissimilar.

For example, in some embodiments according to the present disclosure the first mating seal ring 12 is composed of stellite and the second mating seal ring 13 is composed of C6, a nickel alloy. Stellite is a high iron alloy that is about 60-70% iron by weight. C6 is a nickel alloy that is about 75% nickel by weight. Stellite and C6 are dissimilar metals because iron is the dominant element in the stellite and nickel is the dominant element in C6.

In other embodiments according to the present disclosure the first mating seal ring 12 is composed of nihard and the second mating seal ring 13 is composed of C6. Nihard is a high alloy iron, which is about 90% iron by weight, whereas the C6 is about 75% nickel by weight. Therefore, nihard and C6 is an example of dissimilar metals.

In other embodiments according to the present disclosure the first mating seal ring 12 is composed of SAE 52100 steel and the second mating seal ring 13 is composed of C6. SAE 52100 steel is a low alloy steel that is about 96% iron by weight, whereas C6 is about 75% nickel by weight. Therefore, SAE 52100 steel and C6 is an example of dissimilar metals.

As shown in FIGS. 2 and 3, the seal assembly 10 has a first mating seal ring 12 having a first mating surface 23. The seal assembly 10 further includes a second mating seal ring 13 having a second mating surface 23′. The first and second mating surfaces 23, 23′ may be formed of metals that are dissimilar from each other.

In some embodiments according to the present disclosure, each mating seal ring 12, 13 may include a coating 16, 18 disposed on the mating surface 23, 23′ of each mating seal ring 12, 13. The coatings 16, 18 in this instance are formed of metals that are dissimilar from each other. In other embodiments according to the present disclosure, the first and second coatings 16, 18 may be disposed on the entire outer surface of the first and second mating seal rings 12, 13.

A wide variety of metals may be used to form the first and second coatings 16, 18 provided that the metals selected are dissimilar metals. By dissimilar, it is meant that the metals selected may have a high difference in bulk chemical composition. In other words, the dominant element in one metal may be present in an amount that is 60% or greater than is present in the other metal. Selecting metals for the first and second coatings 16, 18 that are dissimilar from each other will result in seal rings 12, 13 that are more resistant to galling and therefore enable the seal assembly 10 to operate at higher speeds without failure. Mating seal rings 12, 13 having coatings 16, 18 composed of dissimilar metals were tested and shown to operate at speeds 30% higher than other seals having seal rings 12, 13 that were composed of metals that were not dissimilar.

Many different combinations of dissimilar metals may be used as the first and second coatings 16, 18 as set forth below. Other dissimilar metal combinations, however, may be used as the first and second coatings 16, 18.

In some embodiments according to the present disclosure, the first coating 16 may be a tungsten carbide-cobalt coating and the second coating 18 may be a C6, a nickel alloy, coating. The tungsten carbide-cobalt coating may be about 80% tungsten carbide by weight and about 20% cobalt by weight. The C6 coating may be at least about 75% nickel by weight.

In some embodiments according to the present disclosure, the first coating 16 may be a tungsten carbide-cobalt coating and the second coating 18 may be a chrome carbide-nickel-chrome coating. The tungsten carbide-cobalt coating may be about 80% tungsten carbide by weight and about 20% cobalt by weight. The chrome carbide-nickel-chrome coating may be about 75% chrome carbide by weight and about 25% nickel-chrome by weight.

In some embodiments according to the present disclosure, the first coating 16 may be a tungsten carbide-cobalt coating and the second coating 18 may be SAE 440C stainless steel coating. The tungsten carbide-cobalt coating may be about 80% tungsten carbide by weight and about 20% cobalt by weight. The SAE 440C stainless steel coating may be about 75% carbide by weight and about 25% nickel-chrome by weight.

In some embodiments according to the present disclosure, the first coating 16 may be a tungsten carbide-C6 coating and the second coating 18 may be a stellite coating. The tungsten carbide-C6 coating may be about 80% tungsten carbide by weight and about 20% C6 by weight. The stellite coating may be at least about 75% nickel by weight.

In some embodiments according to the present disclosure, the first coating 16 may be chrome oxide-titanium oxide coating and the second coating 18 may be C6 coating, a nickel alloy coating. The chrome oxide-titanium oxide coating may be about 99% chrome oxide by weight and about 1% titanium oxide by weight. The C6 coating may be about 75% nickel by weight.

In some embodiments according to the present disclosure, the first coating 16 may be a chrome carbide-nickel chrome and the second coating 18 may be C6, a nickel alloy coating. The first coating 16 may be about 50% chrome carbide and about 50% nickel chrome. The second coating 18 may be 75% nickel.

In some embodiments according to the present disclosure, the first coating 16 may be a chrome carbide-nickel chrome coating and the second coating 18 may be a tungsten carbide-cobalt coating. The chrome carbide-nickel chrome coating may be about 99% chrome oxide by weight and about 1% titanium oxide by weight. The tungsten carbide-cobalt coating may be about 80% tungsten carbide and about 20% cobalt.

It is noted that if there are dissimilar metal coatings 16, 18 disposed on the mating surfaces 23, 23′, then the first and second mating seal rings 12, 13 may be formed from non-metal materials. Suitable non-metal materials may include ceramics or polymers such as nylon. Further, seal rings 12, 13 may be formed using the same metals or metals that are not dissimilar to each other. Suitable materials for the first and second mating seal rings 12, 13 may also be selected based on a number of other factors, including bondability with coatings 16, 18, cost, machinability, or any other suitable factor. First and second mating seal rings 12, 13 may be fabricated by forging or precision casting followed by machining to a desired size and shape.

Coatings 16, 18 may be applied using a number of suitable processes and materials. In some embodiments according to the present disclosure, thermal spray techniques are used for higher adhesion and strength. Methods such as high velocity oxygen fuel and laser cladding may be used to apply the coatings 16, 18 to the mating seal rings 12, 13. Other coating methods known in the art may be used as long as the bond strength is high enough to be used for a floating style seal.

For example, a variety of suitable electroless plating processes may be used to produce a suitable coating. Generally, suitable plating processes will begin by pretreating or cleaning a substrate surface. A variety of pretreatment or cleaning processes may be selected. The specific pretreatment or cleaning process may be chosen based on the substrate being coated, the type of coating material being applied, desired speed, cost, or any other suitable factor. Suitable pretreatment or cleaning processes may include combinations of solvent washing, rinsing degreasing, and electrocleaning Further, some substrates may also require chemical activation to facilitate electroless plating. Any suitable pretreatment or cleaning process may be selected.

After pretreatment or cleaning, electroless plating may be performed using a plating solution. The solution will include a solvent (eg. water), ions of one or more metals to be plated on a substrate material, and a reducing agent. The metal ions will be provided using, for example, a metal salt that is at least partially soluble in the solution solvent. In the case of nickel, the metal salt may include, for example, nickel chlorides, nickel sulfates, nickel formates, nickel acetates, and/or any other suitable nickel salt that is soluble in the solution. In some embodiments, the salt may be selected such that the salt anions will not interfere with the electroless plating process or will not produce undesired coating properties.

As shown in FIG. 3, coatings 16, 18 are disposed on opposing mating surfaces 23, 23′ of mating seal rings 12, 13 at seal interface 26. In this way, coatings 16, 18 will provide a hard, wear resistant surface to portions of seal rings 12, 13 that may be subject to certain degrees of wear and abrasion. In some embodiments according to the present disclosure, the first and second coatings 16, 18 are hard face metal coatings. The hard face metal coatings may be applied to the mating surfaces 23, 23′ by various methods such as laser cladding and plasma arc spray methods. Alternatively, high velocity oxygen fuel (HVOF) methods may be used to apply hard face metal coatings to the mating seal rings 12, 13.

In other embodiments, it may be desirable to apply coatings 16, 18 to additional sections of the seal rings 12, 13. For example, in some embodiments, coatings 16, 18 may cover the entire surface of the seal rings 12, 13, and not only the mating surfaces 23, 23′. The extent of coating coverage may be selected based on a number of factors. For example, in some embodiments, it may be easier or faster to apply a coating 15, 16 to the entire surface of the seal rings 12, 13 than to mask certain sections of the seal rings 12, 13. The dissimilar metal coatings 16, 18, however, should cover the first and second mating surfaces 23, 23′ to ensure the floating style seal may be able to operate at higher speeds without galling and failure due to adhesive wear.

It should be noted, in some embodiments, it may be desirable to include a coating on one seal ring 12, 13 but not on both seal rings 12, 13. In this instance, the seal ring 12, 13 the mating surface 23, 23′ must be formed of a metal that is dissimilar to the coating 16, 18 disposed on the opposing mating surface 23, 23′. In other words, the first mating surface 23 may be composed of a metal that is dissimilar to the second coating 18. Alternatively, the first coating 16 may be composed of a metal that is dissimilar to the second mating surface 23′.

### INDUSTRIAL APPLICABILITY

The present disclosure provides a floating style seal assembly 10 having mating seal rings 12, 13 composed of dissimilar metals. The seal assemblies 10 may be used in any application in which floating style seals are used. Examples of suitable applications may be many types of industrial equipment including trucks and track-type machines that typically operate in environments that are highly destructive to seals and consequently to the underlying bearings.

Current seal materials include a wide variety of materials such as hard metals, alloys, ceramics and nylon. Some seal materials are expensive and their durability can be a life-limiting factor for seal rings. Seal rings using these seal materials often fail due to adhesive wear failure or galling, especially when the seal is used at higher operating speeds.

The seal assemblies 10 of the present disclosure use seal rings 12, 13 that are composed of dissimilar metals. Using dissimilar metals for the seal rings 12, 13 enables the seal to operate at higher operating speeds without failure. In some instances, operating speeds that are 30% higher may be achieved by using the seal assemblies 10 of the present disclosure.

Any metal can be used to construct the seal rings 12, 13 of the present disclosure, provided metals that are dissimilar from each other are selected. The seal rings 12, 13 may be constructed such that that both rings as a whole are composed of a dissimilar metal. The seal rings 12, 13 may also be constructed such that only the sealing interfaces of the rings are composed of dissimilar metals. Additionally, metal coatings 16, 18 may be applied to seal rings 12, 13 provided that the coatings 16, 18 are of dissimilar metals. Further, these coatings may be applied to relatively inexpensive seal rings 12, 13 to reduce overall seal ring cost. Metal coatings 16, 18 may be applied to the seal rings 12, 13 using methods such as laser cladding, plasma arc spray and high velocity oxygen fuel methods.

The seal assemblies 10 of the present disclosure are more wear resistant at higher operating speeds. Seal ring life is significantly improved thereby saving significant cost due to repairs, replacements, and machine down time that may result from operating seals at higher speeds.

The many features and advantages of the disclosure are apparent from the detailed specification, and, thus, it is intended by the appended claims to cover all such features and advantages of the disclosure, which fall within its true spirit and scope. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A seal assembly comprising: a first mating seal ring and a second mating seal ring wherein the first and second mating seal rings comprise metals dissimilar from each other and the seal assembly is a floating style seal.

2. The seal assembly of claim 1, wherein the first mating seal ring comprises stellite and the second mating seal ring comprises nickel alloy.

3. The seal assembly of claim 2, wherein the stellite includes between about 60% to about 70% iron by weight and the nickel alloy includes at least about 75% nickel by weight.

4. The seal assembly of claim 1, wherein the first mating seal ring has a first mating surface and a first coating disposed on the first mating surface and the second mating seal ring has a second mating surface and a second coating disposed on the second mating surface, wherein the first and second coatings comprise metals dissimilar from each other.

5. The seal assembly of claim 1, wherein the first or second mating seal ring comprises a metal selected from the group consisting of: stellite, nickel alloy, iron alloy, nihard, and steel.

6. The seal assembly of claim 4, wherein the first and second mating seal rings are composed of non-metal materials.

7. The seal assembly of claim 4, wherein the first and second mating seal rings are composed of the same material.

8. The seal assembly of claim 4, wherein the first coating comprises a tungsten carbide-cobalt coating and the second coating comprises a nickel alloy coating.

9. The seal assembly of claim 8, wherein the tungsten carbide coating includes about 80% tungsten carbide by weight and about 20% cobalt by weight, and the nickel alloy coating includes at least about 75% nickel by weight.

10. The seal assembly of claim 4, wherein the first coating is disposed on the entire surface of the first mating seal ring.

11. The seal assembly of claim 4, wherein the first coating is disposed on the entire surface of the first mating seal ring and the second coating is disposed on the entire surface of the second mating seal ring.

12. A method of making a seal assembly comprising:
providing a first mating seal ring; and
providing a second mating seal ring wherein the first and second mating seal rings comprise metals dissimilar from each other and the seal assembly is a floating style seal.

13. The method of claim 12, wherein the first mating seal ring comprises stellite and the second mating seal ring comprises nickel alloy.

14. The method of claim 13, wherein the stellite includes between about 60% to about 70% iron by weight and the nickel alloy includes at least about 75% nickel by weight.

15. The method of claim 12, wherein the first or second mating seal ring comprises a metal selected from the group consisting of: stellite, nickel alloy, iron alloy, nihard, and steel.

16. The method of claim 12, further comprising applying a first coating on the first mating seal ring and applying a second coating on the second mating seal ring wherein the first and second coatings comprise metals dissimilar from each other.

17. The method of claim 16, wherein the first coating includes a tungsten carbide-cobalt coating and the second coating includes a nickel alloy coating.

18. The method of claim 17, wherein the tungsten carbide coating includes about 80% tungsten carbide by weight and about 20% cobalt by weight, and the nickel alloy coating includes at least about 75% nickel by weight.

19. The method of claim 14, wherein the first or second coating is applied using high velocity oxygen fuel, laser cladding, plasma arc spray methods or electroless plating.

20. A method of making a seal assembly comprising:
a means for providing a first mating seal ring and
a means for providing a second mating seal ring wherein the first and second mating seal rings comprise metals dissimilar from each other and the seal assembly is a floating style seal.
